(19) United States
(12) Patent Application Publication
(10) Pub. No.: US 2025/0256797 A1
(43) Pub. Date: Aug. 14, 2025

(54) STORAGE DEVICE FOR BICYCLE

(71) Applicant: Louis CHUANG, Taichung (TW)

(72) Inventor: Louis CHUANG, Taichung (TW)

(21) Appl. No.: 19/192,932

(22) Filed: Apr. 29, 2025

Related U.S. Application Data
(63) Continuation of application No. 18/297,121, filed on Apr. 7, 2023.

(30) Foreign Application Priority Data
Sep. 15, 2022 (TW) 111134958

(51) Int. Cl. B62J 9/22

(52) U.S. Cl. CPC B62J 9/22

(57) ABSTRACT

A storage device includes a rack and at least one first cutter. The rack defines a top surface and a bottom surface opposite to the top surface in a height direction thereof. The rack includes at least one pair of insertion holes communicating with the top surface and the bottom surface. The cutter has a pair of insertion portions and a cutting portion formed between the pair of insertion portions. The pair of insertion portions are detachably inserted into the at least one pair of insertion holes. When the pair of insertion portions are inserted into the pair of insertion holes, the cutting portion faces the rack.

### CROSS-REFERENCE TO RELATED APPLICATIONS

The present application is a continuation-in-part of U.S. patent application Ser. No. 18/297,121, filed on Apr. 7, 2023, now pending, which claims the benefit of priority to Taiwan Patent Application No. 111134958, filed on Sep. 15, 2022, now issued as Taiwan Patent No. 1840948B, the entire disclosure of which is incorporated herein by reference in its entirety for all purposes.

### BACKGROUND OF THE INVENTION

The present invention relates to a storage device and, more particularly, to a storage device for a bicycle.

U.S. Pat. No. 9,840,295 discloses a bicycle bag including a bag body and at least one adjusting belt assembly. The bag body is adapted to store bicycle accessories and includes a first penetration portion and a second penetration portion. The at least one adjusting belt assembly is selectively inserted through one of the first and second penetration portions to form a suspending portion attachable to a bicycle. Thus, the bicycle bag can be attached to an up tube or a seat post of a bicycle, or attached between the saddle and the seat post of a bicycle to meet user needs.

However, the above bicycle bag is attached to the bicycle by adjusting the belt assembly for hanging. This attaching method causes inconvenience in use as the adjusting belt assembly needs to be readjusted every time the bicycle bag is attached to or removed from the bicycle.

Thus, a need exists for a storage device to mitigate and/or obviate the above disadvantages.

### SUMMARY OF THE INVENTION

An objective of the present invention is to provide a storage device, which includes a rack and a storage bag assembly. The rack has a top surface and a bottom surface opposite to the top surface in a height direction. The rack defines a first side and a second side opposite to the first side in a width direction. The rack is provided with a plurality of engaging slots distributed on either the first side or the second side. The storage bag assembly is detachably connected to the top surface of the rack, and the storage bag assembly is provided with a plurality of engaging portions. When the storage bag assembly is connected to the rack, the plurality of engaging portions are engaged in the plurality of engaging slots and abutted against the bottom surface.

In an embodiment, the rack is provided with an even number of engaging slots arranged in pairs and symmetrically on the first side and the second side, and the storage bag assembly is provided with an even number of engaging portions. When the storage bag assembly is connected to the rack, the even number of engaging portions are engaged in the even number of engaging slots and abutted against the bottom surface.

In an embodiment, the storage device further includes a plurality of binding straps respectively looping around the top surface and the bottom surface and sleeving on the rack. When the storage bag assembly is connected to the rack, the storage bag assembly covers sides of the plurality of binding straps opposite to the top surface. When the storage bag assembly is detached from the rack, the plurality of binding straps is flexibly deformed to stretch or shrink.

In an embodiment, the rack is further provided with a plurality of recesses extending through the top surface, the first side, the bottom surface, and the second side to surround around the rack. The plurality of binding straps are respectively arranged in the plurality of recesses.

In an embodiment, the rack defines a first end and a second end opposite to the first end in a length direction. The rack is further provided with an elongated slot arranged on the top surface and extended from the first end to the second end. The storage bag assembly is further provided with a limiting portion being flexibly deformable. When the storage bag assembly is connected to the rack, the limiting portion is arranged in the elongated slot and abuts against a side wall of the elongated slot adjacent to the first end.

In an embodiment, the storage bag assembly is further provided with a connecting member and a bag member. The plurality of engaging portions and the limiting portion are disposed at a bottom edge of the connecting member. The bag member is connected to a top edge of the connecting member.

In an embodiment, the rack is connected with two fixing straps. The two fixing straps are respectively connected to the bottom surface. One of the two fixing straps is adjacent to the first end and the other fixing strap is adjacent to the second end.

In another embodiment, the rack is connected with two locking members. Each of the two locking members has a threaded portion arranged on an outer periphery thereof. The two locking members respectively penetrate through the top surface and are exposed on the bottom surface.

Another objective of the present invention is to provide a storage device, which includes a rack and at least one cutter. The rack defines a top surface and a bottom surface opposite to the top surface in a height direction thereof. The rack includes at least one pair of insertion holes communicating with the top surface and the bottom surface. The at least one cutter has a pair of insertion portions and a cutting portion formed between the pair of insertion portions. The pair of insertion portions are detachably inserted into the at least one pair of insertion holes, and when the pair of insertion portions are inserted into the pair of insertion holes, the cutting portion faces the rack.

In an embodiment, the rack further includes at least one transverse groove recessed on the top surface and interconnected with the at least one pair of insertion holes in a width direction thereof. When the pair of insertion portions are inserted into the at least one pair of insertion holes, the cutting portion is disposed in the least one transverse groove.

In an embodiment, the cutting portion is formed in a serrated shape.

In an embodiment, the rack further includes three pairs of insertion holes and three transverse grooves interconnected to form a first unitary through-hole. The storage device further includes three cutters respectively detachably mounted in the three pair of insertion holes and the three transverse grooves.

In an embodiment, an outer periphery of the rack defines a first side and a second side opposite to the first side in the width direction. The rack includes a total of six pairs of insertion holes and six transverse grooves. A first group of three pairs of insertion holes and three transverse grooves are interconnected to form the first unitary through-hole, and a second group of three pairs of insertion holes and three transverse grooves are interconnected to form a second unitary through-hole. Each pair of insertion holes is respectively disposed adjacent to the first side and the second side, and each transverse groove extends between the first side and the second side.

In an embodiment, the storage device further includes at least one fastening strap defining a first end and a second end, and sequentially provided from the first end toward the second end with a first section, a second section, a third section, a fourth section, and a fifth section. The first end is disposed on the bottom surface, wherein the second end sequentially passes through the second group of three pairs of insertion holes and three transverse grooves, thereby forming the first section, the second section, the third section, the fourth section, and the fifth section.

In an embodiment, the rack further includes a third unitary through-hole and a fourth unitary through-hole each formed by interconnecting three pairs of insertion holes and three transverse grooves. The at least one fastening strap includes three fastening straps respectively disposed in the second unitary through-hole, the third unitary through-hole, and the fourth unitary through-hole.

In an embodiment, the first unitary through-hole and the second unitary through-hole define a first set, and the third unitary through-hole and the fourth unitary through-hole define a second set. The first set and the second set are symmetrically arranged in a length direction of the rack.

In an embodiment, The storage device further comprises a storage bag detachably connectable to the top surface. When the storage bag is connected to the top surface, the storage bag covers the first unitary through-hole and the second unitary through-hole.

In an embodiment, the top surface has a retaining portion recessed thereon. The storage bag has a stopper portion, which is elastically deformable and engageable with the retaining portion.

The present invention will become clearer in light of the following detailed description of illustrative embodiments of this invention described in connection with the drawings.

### BRIEF DESCRIPTION OF DRAWINGS

FIG. 1 is a perspective view of a storage device of a first embodiment according to the present invention.

FIG. 2 is an exploded perspective view of the storage device of FIG. 1.

FIG. 3 is another exploded perspective view of the storage device of FIG. 1.

FIG. 4 is a cross sectional view of the storage device of FIG. 1.

FIG. 5 is another cross sectional view of the storage device of FIG. 1.

FIG. 6 is a perspective view of a storage device of a first embodiment according to the present invention and shows the storage device mounted to a bicycle.

FIG. 7 is a cross sectional view of a storage device of a second embodiment according to the present invention.

FIG. 8 is a perspective view of a storage device of a third embodiment according to the present invention.

FIG. 9 is an exploded perspective view of a rack of the storage device of FIG. 8.

FIG. 10 is a front cross sectional view of the storage device of FIG. 8.

FIG. 11 is another front cross sectional view of the storage device of FIG. 8.

FIG. 12 is a side cross sectional view of the storage device of FIG. 8.

### DETAILED DESCRIPTION OF THE INVENTION

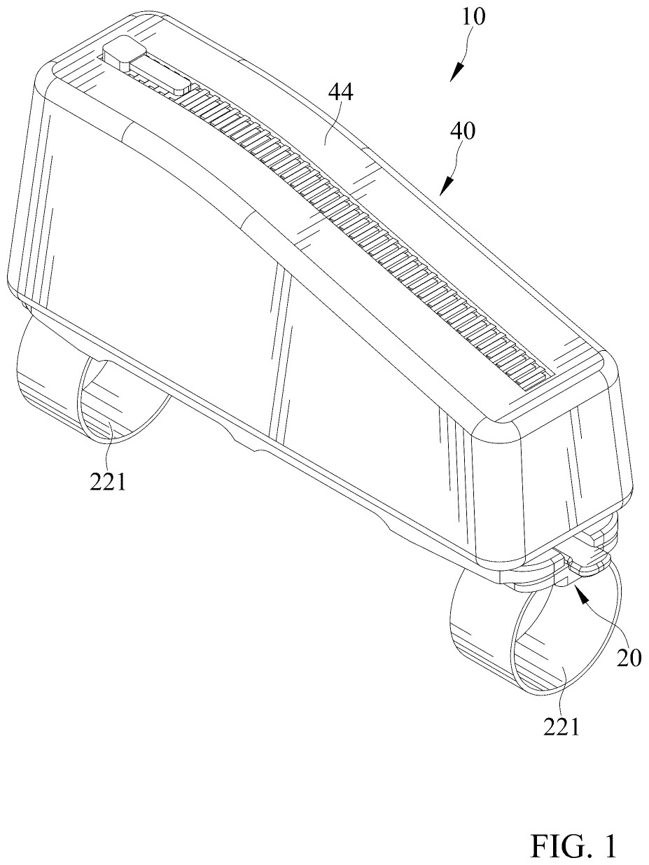

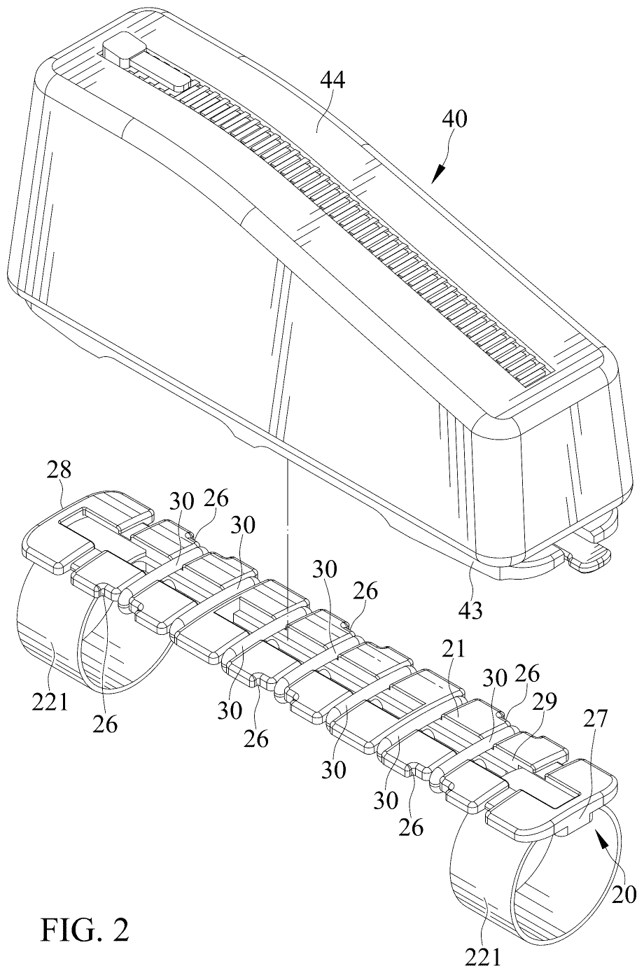

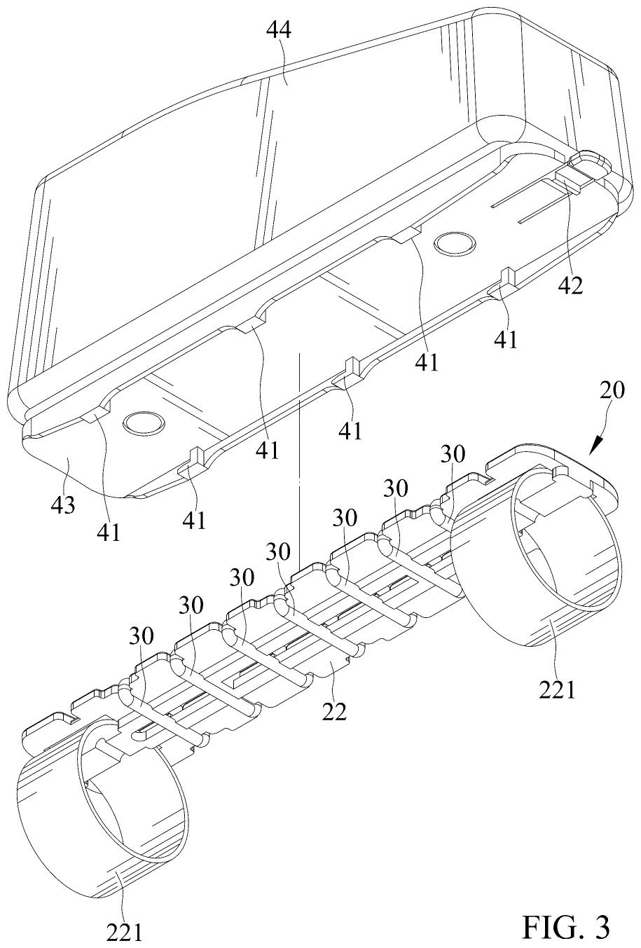

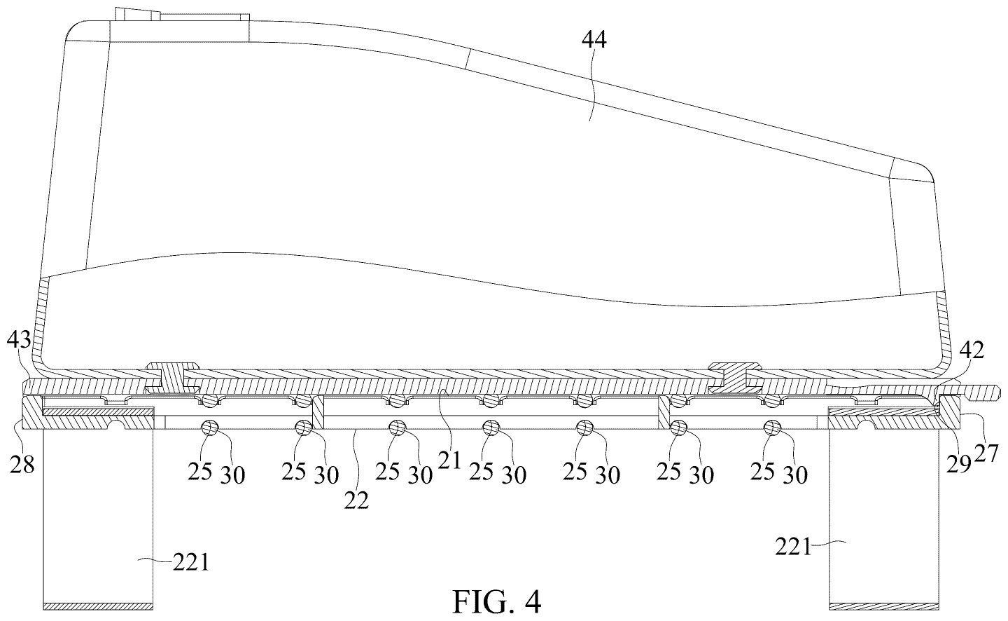

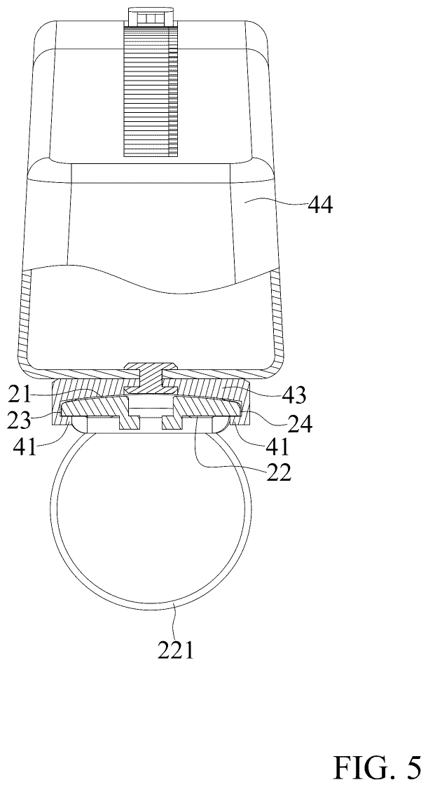

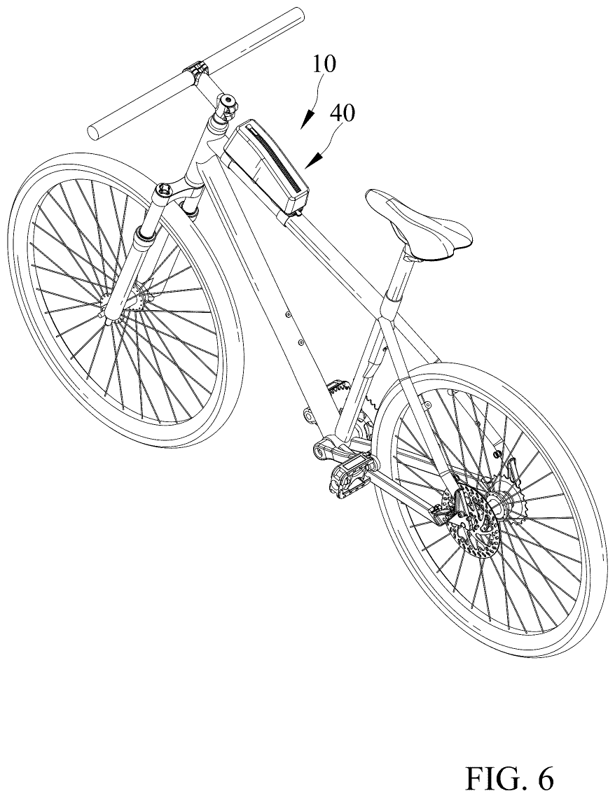

FIGS. 1-6 show a storage device 10 of a first embodiment according to the present invention. The storage device 10 includes a rack 20, a plurality of binding straps 30 and a storage bag assembly 40.

The rack 20 has a top surface 21 and a bottom surface 22 opposite to the top surface 21 in a height direction.

The plurality of binding straps 30 respectively loop around the top surface 21 and the bottom surface 22 and sleeve on the rack 20.

The storage bag assembly 40 is detachably connected to the top surface 21 of the rack 20. When the storage bag assembly 40 is connected to the rack 20, the storage bag assembly 40 covers sides of the plurality of binding straps 30 opposite to the top surface 21. When the storage bag assembly 40 is detached from the rack 20, the plurality of binding straps 30 is flexibly deformed to stretch or shrink.

The rack 20 defines a first side 23 and a second side 24 opposite to the first side 23 in a width direction. The rack 20 is further provided with a plurality of recesses 25 extending through the top surface 21, the first side 23, the bottom surface 22, and the second side 24 to surround around the rack 20, and the plurality of binding straps 30 are respectively arranged in the plurality of recesses 25.

The rack 20 is provided with a plurality of engaging slots 26 distributed on either the first side 23 or the second side 24. The storage bag assembly 40 is provided with a plurality of engaging portions 41. When the storage bag assembly 40 is connected to the rack 20, the plurality of engaging portions 41 are engaged in the plurality of engaging slots 26 and abutted against the bottom surface 22.

The rack 20 of this embodiment is provided with an even number of engaging slots 26 arranged in pairs and symmetrically on the first side 23 and the second side 24. The storage bag assembly 40 is provided with an even number of engaging portions 41. When the storage bag assembly 40 is connected to the rack 20;20a, the even number of engaging portions 41 are engaged in the even number of engaging slots 26 and abutted against the bottom surface 22.

The rack 20 defines a first end 27 and a second end 28 opposite to the first end 27 in a length direction. The rack 20 is further provided with an elongated slot 29 arranged on the top surface 21 and extended from the first end 27 to the second end 28. The storage bag assembly 40 is further provided with a limiting portion 42 being flexibly deformable. When the storage bag assembly 40 is connected to the rack 20, the limiting portion 42 is arranged in the elongated slot 29 and abuts against a side wall of the elongated slot 29 adjacent to the first end 27.

The storage bag assembly 40 is further provided with a connecting member 43 and a bag member 44. The plurality of engaging portions 41 and the limiting portion 42 are disposed at a bottom edge of the connecting member 43, and the bag member 44 is connected to a top edge of the connecting member 43.

The rack 20 is connected with two fixing straps 221, which are respectively connected to the bottom surface 22. One of the two fixing straps 221 is adjacent to the first end 27 and the other fixing strap 221 is adjacent to the second end 28.

Thus, the storage device 10 can provide a storage bag assembly 40 that can be quickly attached and detached to a bicycle. The rack 20 can be attached to the bicycle frame through the two fixing straps 221, and the storage bag assembly 40 can be attached to the bicycle through the rack 20. The storage bag assembly 40 can be quickly attached to or detached from the bicycle, and the binding straps 30 can also be used to tie objects.

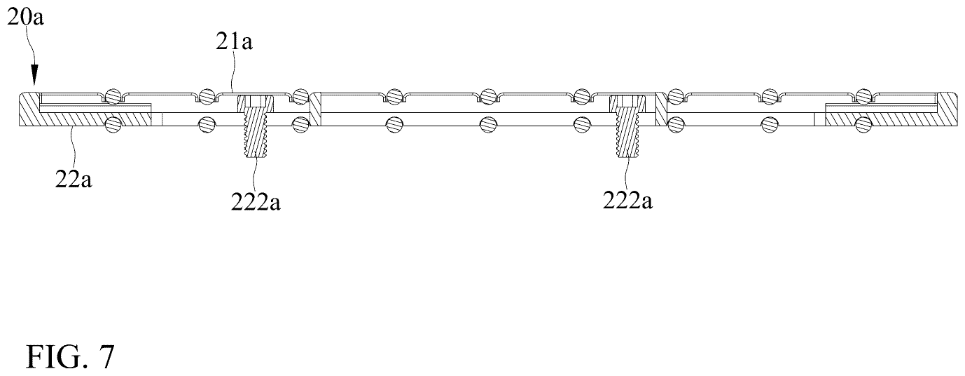

FIG. 7 shows a storage device 10 of a second embodiment according to the present invention. The second embedment is substantially the same as the first embodiment. The main differences are that the rack 20a is connected with two locking members 222a. Each of the two locking members 222a has a threaded portion arranged on an outer periphery thereof. The two locking members 222a respectively penetrate through the top surface 21a and are exposed on the bottom surface 22a.

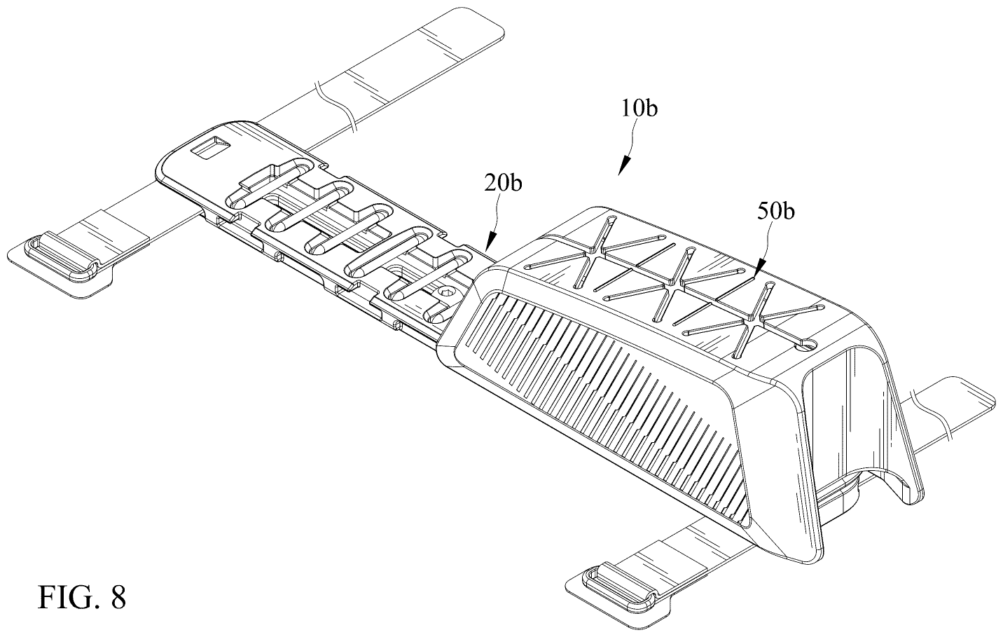

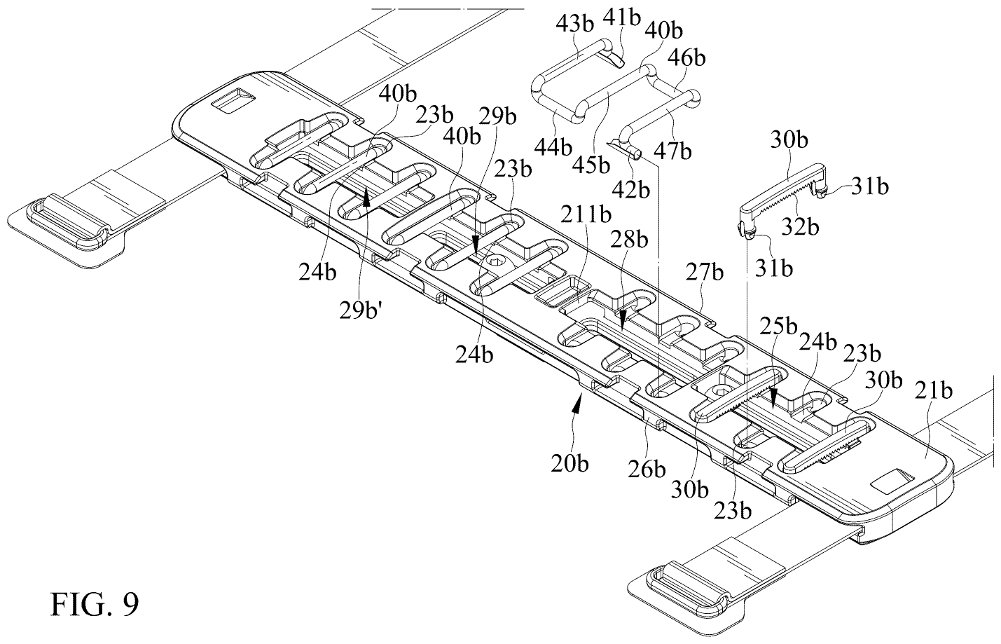

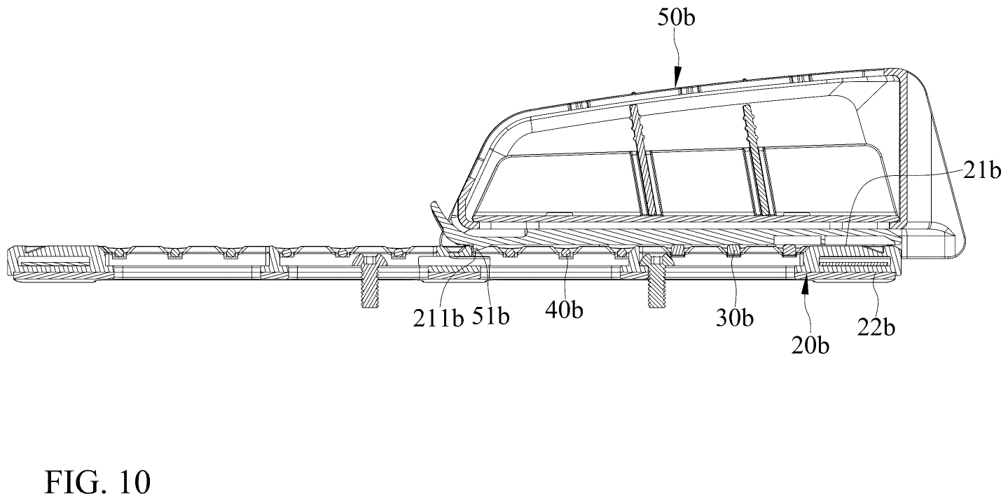

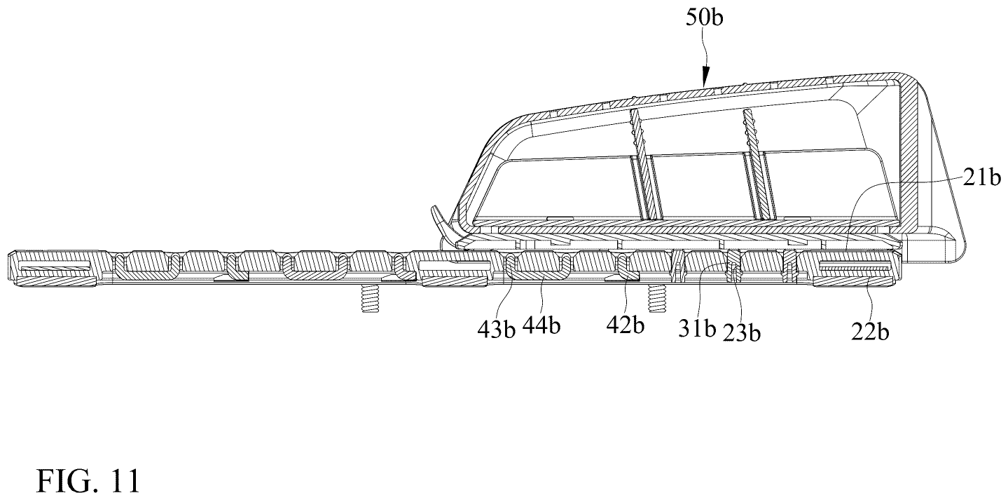

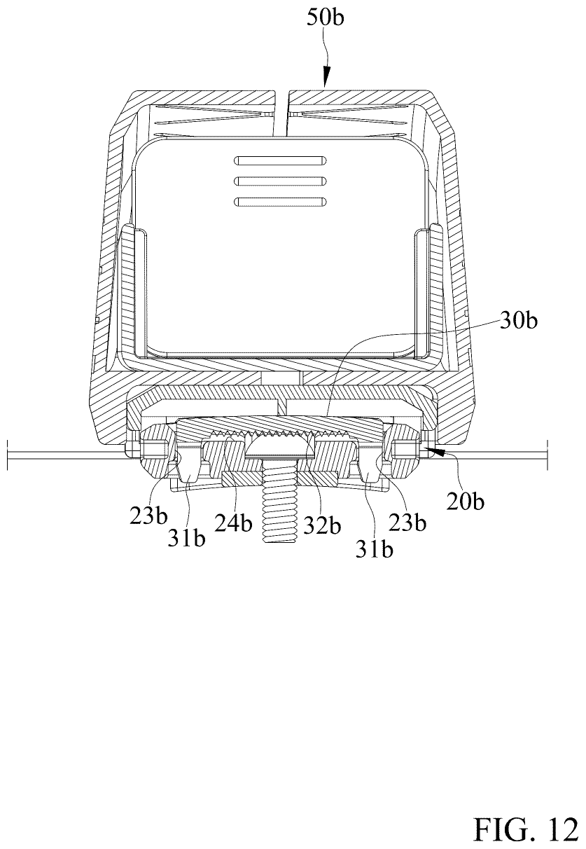

FIGS. 8-12 shows a storage device 10b of a third embodiment according to the present invention. The third embedment of the storage device 10b includes a rack 20b and at least one cutter 30b. The rack 20b defines a top surface 21b and a bottom surface 22b opposite to the top surface 21b in a height direction thereof. The rack 20b includes at least one pair of insertion holes 23b communicating with the top surface 21b and the bottom surface 22b. The at least one cutter 30b has a pair of insertion portions 31b and a cutting portion 32b formed between the pair of insertion portions 31b. The insertion portions 31b are detachably inserted into the corresponding pair of insertion holes 23b, such that the cutting portion 32b faces the rack 20b when mounted.

The rack 20b further includes at least one transverse groove 24b recessed on the top surface 21b and interconnected with the at least one pair of insertion holes 23b in a width direction thereof. When the cutter 30b is mounted, the cutting portion 32b is disposed within the transverse groove 24b. Preferably, the cutting portion 32b is formed in a serrated shape to facilitate cutting.

In an embodiment, three pairs of insertion holes 23b and three transverse grooves 24b interconnected are interconnected to form a first unitary through-hole 25b. Three cutters 30b may be mounted in the three pair of insertion holes 23b and the three transverse grooves 24b.

An outer periphery of the rack 20b defines a first side 26b and a second side 27b opposite to the first side 26b in the width direction. The rack 20b may include a total of six pairs of insertion holes 23b and six transverse grooves 24b, wherein a first group of three pairs of insertion holes 23b and three transverse grooves 24b, which are divided into a first group and a second group, respectively forming a first unitary through-hole 25b and a second unitary through-hole 28b. Each pair of insertion holes 23b is respectively disposed adjacent to the first side 26b and the second side 27b, and wherein each transverse groove 24b extends between the first side 26b and the second side 27b.

The storage device 10b further includes at least one fastening strap 40b defining a first end 41b and a second end 42b, and sequentially provided from the first end 41b toward the second end 42b with a first section 43b, a second section 44b, a third section 45b, a fourth section 46b, and a fifth section 47b. The first end 41b is disposed on the bottom surface 22b, and the second end 42b sequentially passes through the second group of three pairs of insertion holes 23b and three transverse grooves 24b, thereby forming the first section 43b, the second section 44b, the third section 45b, the fourth section 46b, and the fifth section 47b.

The rack 20b further includes a third unitary through-hole 29b and a fourth unitary through-hole 29b′, each formed by interconnecting three pairs of insertion holes 23b and three transverse grooves 24b. The at least one fastening strap 40b includes three fastening straps 40b respectively disposed in the second unitary through-hole 28b, the third unitary through-hole 29b, and the fourth unitary through-hole 29b′.

The first unitary through-hole 25b and the second unitary through-hole 28b define a first set, the third unitary through-hole 29b and the fourth unitary through-hole 29b′ define a second set, and the first set and the second set are symmetrically arranged in a length direction of the rack 20b.

In addition, a storage bag 50b may be detachably mounted to the top surface 21b of the rack 20b. When connected, the storage bag 50b covers the first unitary through-hole 25b and the second unitary through-hole 28b. In other words, the third unitary through-hole 29b and the fourth unitary through-hole 29b′ remain exposed. The top surface 21b may be provided with a retaining portion 211b recessed thereon, while the storage bag 50b includes an elastically deformable stopper portion 51b engageable with the retaining portion 211b, allowing for stable yet removable attachment.

The present invention provides a highly practical and multifunctional structure particularly suitable for cycling applications. For example, during a bicycle ride, an energy gel packet can be secured between the cutting portion 32b of the cutter 30b and the corresponding transverse groove 24b, allowing the rider to tear the packet open against the cutter 30b with one hand without stopping or using additional tools. By covering only a portion of the through-hole regions, the storage bag 50b provides selective protection while maintaining accessibility. When installed, the storage bag 50b covers the first and second unitary through-holes 25b and 28b, while the third and fourth unitary through-holes 29b and 29b′ remain exposed. This configuration enables quick access to items secured by the fastening straps 40b, such as energy gels, gloves, or towels, and facilitates on the go operations without the need to remove the storage bag 50b or interrupt the activity. As such, the storage device 10b offers both organized storage and immediate accessibility, greatly enhancing usability and efficiency in real world cycling scenarios.

Although specific embodiments have been illustrated and described, numerous modifications and variations are still possible without departing from the scope of the invention. The scope of the invention is limited by the accompanying claims.

1. A storage device comprising:
a rack defining a top surface and a bottom surface opposite to the top surface in a height direction thereof, wherein the rack includes at least one pair of insertion holes communicating with the top surface and the bottom surface; and
at least one cutter having a pair of insertion portions and a cutting portion formed between the pair of insertion portions, wherein the pair of insertion portions are detachably inserted into the at least one pair of insertion holes, and wherein when the pair of insertion portions are inserted into the pair of insertion holes, the cutting portion faces the rack.

2. The storage device as claimed in claim 1, wherein the rack further includes at least one transverse groove recessed on the top surface and interconnected with the at least one pair of insertion holes in a width direction thereof, and wherein when the pair of insertion portions are inserted into the at least one pair of insertion holes, the cutting portion is disposed in the least one transverse groove.

3. The storage device as claimed in claim 1, wherein the cutting portion is formed in a serrated shape.

4. The storage device as claimed in claim 2, wherein the rack further includes three pairs of insertion holes and three transverse grooves interconnected to form a first unitary through-hole, and wherein the storage device further includes three cutters respectively detachably mounted in the three pair of insertion holes and the three transverse grooves.

5. The storage device as claimed in claim 4, wherein an outer periphery of the rack defines a first side and a second side opposite to the first side in the width direction, wherein the rack includes a total of six pairs of insertion holes and six transverse grooves, wherein a first group of three pairs of insertion holes and three transverse grooves are interconnected to form the first unitary through-hole, wherein a second group of three pairs of insertion holes and three transverse grooves are interconnected to form a second unitary through-hole, wherein each pair of insertion holes is respectively disposed adjacent to the first side and the second side, and wherein each transverse groove extends between the first side and the second side.

6. The storage device as claimed in claim 5, wherein the storage device further includes at least one fastening strap defining a first end and a second end, and sequentially provided from the first end toward the second end with a first section, a second section, a third section, a fourth section, and a fifth section, wherein the first end is disposed on the bottom surface, wherein the second end sequentially passes through the second group of three pairs of insertion holes and three transverse grooves, thereby forming the first section, the second section, the third section, the fourth section, and the fifth section.

7. The storage device as claimed in claim 6, wherein the rack further includes a third unitary through-hole and a fourth unitary through-hole each formed by interconnecting three pairs of insertion holes and three transverse grooves, and wherein the at least one fastening strap includes three fastening straps respectively disposed in the second unitary through-hole, the third unitary through-hole, and the fourth unitary through-hole.

8. The storage device as claimed in claim 7, wherein the first unitary through-hole and the second unitary through-hole define a first set, wherein the third unitary through-hole and the fourth unitary through-hole define a second set, and wherein the first set and the second set are symmetrically arranged in a length direction of the rack.

9. The storage device as claimed in claim 6, further comprising:
a storage bag detachably connectable to the top surface, wherein when the storage bag is connected to the top surface, the storage bag covers the first unitary through-hole and the second unitary through-hole.

10. The storage device as claimed in claim 9, wherein the top surface has a retaining portion recessed thereon, and wherein the storage bag has a stopper portion, and wherein the stopper portion is elastically deformable and engageable with the retaining portion.
